(19) United States
(12) Patent Application Publication
(10) Pub. No.: US 2026/0245489 A1
(43) Pub. Date: Aug. 20, 2026

(54) DRIVING CIRCUIT, DRIVING METHOD, DRIVING MODULE, AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN); Beijing BOE Technology Development Co., Ltd., Beijing (CN)

(72) Inventors: Yao HUANG, Beijing (CN); Ming HU, Beijing (CN); Haijun QIU, Beijing (CN); Xiangdan DONG, Beijing (CN); Yongliang ZHAO, Beijing (CN); Dongfang YANG, Beijing (CN); Yang YU, Beijing (CN); Wulin SHEN, Beijing (CN)

(21) Appl. No.: 18/869,776

(22) PCT Filed: Sep. 25, 2023
(86) PCT No.: PCT/CN2023/121181

§ 371 Date: Nov. 26, 2024

(51) Int. Cl. G09G 3/20

(52) U.S. Cl. CPC G09G 3/20; G09G 2300/0426; G09G 2310/0286; G09G 2310/08; G09G 2330/021; G09G 2340/0435

(57) ABSTRACT

A driving circuit, a driving method, a driving module, and a display device are provided. The driving circuit includes a first output circuit, a second output circuit, and a first output node control circuit. The first output circuit controls a driving signal output end to be electrically connected to or electrically disconnected from a first voltage end under the control of a potential of a first output node. The second output circuit controls the driving signal output end to be electrically connected to or electrically disconnected from an output signal end under the control of a potential of a second output node. The first output node control circuit controls the first output node to be electrically connected to or electrically disconnected from a second voltage end under the control of a first output control signal.

### CROSS-REFERENCE TO RELATED APPLICATION

The present application is the U.S. national phase of PCT Application No. PCT/CN 2023/121181 filed on Sep. 25, 2023, which is incorporated herein by reference in its entirety for all purposes.

### TECHNICAL FIELD

The present disclosure relates to the field of display technology, and in particular, to a driving circuit, a driving method, a driving module, and a display device.

### BACKGROUND

During an operation of a display product in related art, when performing low-frequency display, a display period includes a refreshing frame and a maintenance frame; in the maintenance frame, when stopping providing a clock signal and an input signal, there is a step in the driving signal output by the driving signal output end, resulting in abnormally outputting.

### SUMMARY

In one aspect, the embodiments of the present disclosure provide a driving circuit, including a first output circuit, a second output circuit, and a first output node control circuit, wherein
a control end of the first output circuit is electrically connected to a first output node, and the first output circuit is further electrically connected to each of a first voltage end and a driving signal output end, and configured to control the driving signal output end to be electrically connected to or electrically disconnected from the first voltage end under the control of a potential of the first output node;
a control end of the second output circuit is electrically connected to a second output node, and the second output circuit is further electrically connected to each of an output signal end and the driving signal output end, and configured to control the driving signal output end to be electrically connected to or electrically disconnected from the output signal end under the control of a potential of the second output node;
the first output node control circuit is electrically connected to each of a first output control end, a second voltage end, and the first output node, and configured to control the first output node to be electrically connected to or electrically disconnected from the second voltage end under the control of a first output control signal provided by the first output control end.

Optionally, the driving circuit of at least one embodiment of the present disclosure further includes a second output node control circuit, wherein
the second output node control circuit is electrically connected to each of a second output control end, a third voltage end, and the second output node, and configured to control the second output node to be electrically connected to or electrically disconnected from the third voltage end under the control of a second output control signal provided by the second output control end.

Optionally, the first output node control circuit includes a first transistor;
a gate electrode of the first transistor is electrically connected to the first output control end, a first electrode of the first transistor is electrically connected to the second voltage end, and a second electrode of the first transistor is electrically connected to the first output node.

Optionally, the second output node control circuit includes a second transistor;
a gate electrode of the second transistor is electrically connected to the second output control end, a first electrode of the second transistor is electrically connected to the third voltage end, and a second electrode of the second transistor is electrically connected to the second output node.

Optionally, the first output control end and the second output control end are a same output control end; or,
the first output control end and the second output control end are different output control ends.

Optionally, the driving circuit of at least one embodiment of the present disclosure further includes a second node control circuit and an on-off control circuit, wherein
the second node control circuit is electrically connected to a second node, and configured to control a potential of the second node;
the on-off control circuit is electrically connected to each of a fourth voltage end, the second node, and the second output node, and configured to control the second node to be electrically connected to or electrically disconnected from the second output node under the control of a fourth voltage signal provided by the fourth voltage end.

Optionally, the on-off control circuit includes an on-off control transistor;
a gate electrode of the on-off control transistor is electrically connected to the fourth voltage end, a first electrode of the on-off control transistor is electrically connected to the second node, and a second electrode of the on-off control transistor is electrically connected to the second output node;
the on-off control transistor is an n-type transistor, and the fourth voltage end is a high-voltage end; or, the on-off control transistor is a p-type transistor, and the fourth voltage end is a low-voltage end.

Optionally, the driving circuit further includes a first on-off control circuit;
the first output node is electrically connected to the control end of the first output circuit through the first on-off control circuit;
the first on-off control circuit is configured to control the first output node to be electrically connected to the control end of the first output circuit in at least a part of a maintenance period included in a display period.

Optionally, the driving circuit further includes a second on-off control circuit; wherein
the second output node is electrically connected to the control end of the second output circuit through the second on-off control circuit;
the second on-off control circuit is configured to control the second output node to be electrically connected to the control end of the second output circuit in at least a part of a maintenance period included in a display period.

Optionally, the second node control circuit is electrically connected to each of a first clock signal end and a first input end, and configured to control the second node to be electrically connected to or electrically disconnected from the first input end under the control of a first clock signal provided by the first clock signal end.

Optionally, the second node control circuit is further electrically connected to each of the first output node, the first voltage end, and a second clock signal end, and configured to control the second node to be electrically connected to the first voltage end under the control of the potential of the first output node and a second clock signal provided by the second clock signal end.

Optionally, the driving circuit of at least one embodiment of the present disclosure further includes a first output control circuit, wherein
the first output control circuit is electrically connected to each of a first clock signal end, a fifth voltage end, the first output node, a second clock signal end, and the first voltage end, and configured to control the first output node to be electrically connected to the fifth voltage end under the control of a first clock signal provided by the first clock signal end, and control the first output node to be electrically connected to the first voltage end under the control of a second clock signal provided by the second clock signal end.

Optionally, the driving circuit of at least one embodiment of the present disclosure further includes a first output control circuit, wherein
the first output control circuit is electrically connected to each of a first clock signal end, a fifth voltage end, the first output node, and the second node, and configured to control the first output node to be electrically connected to the fifth voltage end under the control of a first clock signal provided by the first clock signal end, and write the first clock signal into the first output node under the control of the potential of the second node.

Optionally, the driving circuit of at least one embodiment of the present disclosure further includes a first energy storage circuit and a second energy storage circuit, wherein
the first energy storage circuit is electrically connected to each of the first output node and the first voltage end, and configured to store electric energy;
the second energy storage circuit is electrically connected to each of the second output node and the driving signal output end, and configured to store electric energy.

Optionally, the driving circuit of at least one embodiment of the present disclosure further includes a first control circuit, wherein
the first control circuit includes a third node control circuit, a fourth node control circuit, and a first node control circuit;
the third node control circuit is electrically connected to each of a third node, a third clock signal end, a fifth voltage end, and the second output node, and configured to control the third node to be electrically connected to the fifth voltage end under the control of a third clock signal provided by the third clock signal end, and write the third clock signal into the third node under the control of the potential of the second output node, and maintain a potential of the third node;
the fourth node control circuit is electrically connected to each of the third node, a fourth clock signal end, and a fourth node, and configured to write a fourth clock signal provided by the fourth clock signal end into the fourth node under the control of the potential of the third node;
the first node control circuit is electrically connected to each of the fourth clock signal end, the fourth node, the first output node, the second output node, and the first voltage end, and configured to control the fourth node to be electrically connected to the first output node under the control of the fourth clock signal, and control the first output node to be electrically connected to the first voltage end under the control of the potential of the second output node.

Optionally, the driving circuit of at least one embodiment of the present disclosure further includes a second output control circuit, wherein the second output control circuit is electrically connected to each of the second output node, a third clock signal end, and a second input end, and configured to control the second output node to be electrically connected to the second input end under the control of a third clock signal provided by the third clock signal end.

In a second aspect, the embodiments of the present disclosure provide a driving method applied to the above driving circuit; wherein a display period includes a refreshing period and a maintenance period; the driving method includes:
in the refreshing period, controlling, by the first output node control circuit, the first output node to be electrically disconnected from the second voltage end under the control of the first output control signal provided by the first output control end;
in at least a part of the maintenance period, controlling, by the first output node control circuit, the first output node to be electrically connected to the second voltage end under the control of the first output control signal provided by the first output control end, to cause the first output circuit to control the driving signal output end to be electrically connected to the first voltage end under the control of the potential of the first output node.

Optionally, the driving circuit further includes a second output node control circuit; the driving method includes the following steps:
in the refreshing period, controlling, by the second output node control circuit, a second output node to be electrically disconnected from a third voltage end under the control of a second output control signal provided by a second output control end; and
in at least a part of the maintenance period, controlling, by the second output node control circuit, the second output node to be electrically connected to the third voltage end under the control of the second output control signal provided by the second output control end, to cause a second output circuit to control the driving signal output end to be electrically disconnected from an output signal end under the control of a potential of the second output node.

Optionally, the driving circuit further includes a first output control circuit; the first output control circuit is electrically connected to a first clock signal end; the driving circuit further includes a second node control circuit and an on-off control circuit; the second node control circuit is electrically connected to the first clock signal end, and the output signal end is a second clock signal end;
a frequency of a first clock signal provided by the first clock signal end and a frequency of a second clock signal provided by the second clock signal end are equal to a frequency of a data voltage provided to a data line in the display period.

Optionally, the first output control end and the second output control end are different output ends;
in the maintenance period, a first period is a period where the first output node is controlled by the first output node control circuit to be electrically connected to the second voltage end; a second period is a period where the second output node is controlled by the second output node control circuit to be electrically connected to the third voltage end; the first period is greater than the second period.

Optionally, the first output control signal is a square wave signal, and the second output control signal is a square wave signal;
a frequency of the first output control signal is greater than a display refreshing frequency, and a frequency of the second output control signal is greater than the display refreshing frequency.

Optionally, in the refreshing period, the first output control signal is a first control voltage signal, and the second output control signal is a second control voltage signal;
in the maintenance period, the first output control signal is a third control voltage signal, and the second output control signal is a fourth control voltage signal;
the first control voltage signal is different from the third control voltage signal, and the second control voltage signal is different from the fourth control voltage signal.

Optionally, the first control voltage signal, the second control voltage signal, the third control voltage signal, and the fourth control voltage signal are direct current voltage signals.

Optionally, the first control voltage signal is a direct current voltage signal, and the second control voltage signal is a square wave voltage signal;
the third control voltage signal is a direct current voltage signal, and the fourth control voltage signal is a square wave voltage signal.

Optionally, the driving method of at least one embodiment of the present disclosure further includes:
in the maintenance period, stopping providing a clock signal to each of clock signal ends, and stopping providing an input signal to each of input ends.

In a third aspect, the embodiments of the present disclosure provide a driving module, including multiple stages of the above driving circuits.

In a fourth aspect, the embodiments of the present disclosure provide a driving method applied to the above driving module; the driving module includes an odd-stage driving circuit and an even-stage driving circuit; the driving circuit includes the first output node control circuit and a second output node control circuit; a display period includes a maintenance period; the driving method includes:
in the maintenance period, stopping providing a clock signal and an input signal to the odd-stage driving circuit;
in at least a part of the maintenance period, in the odd-stage driving circuit, controlling, by the first output node control circuit, the first output node to be electrically connected to the second voltage end, to cause the first output circuit to control the driving signal output end to be electrically connected to the first voltage end; controlling, by the second output node control circuit, the second output node to be electrically connected to a third voltage end, to cause the second output circuit to control the driving signal output end to be electrically disconnected from the output signal end under the control of the potential of the second output node;
in the maintenance period, providing the clock signal and the input signal normally to the even-stage driving circuit.

In a fifth aspect, the embodiments of the present disclosure provide a driving method applied to the above driving module; the driving module includes an odd-stage driving circuit and an even-stage driving circuit; the driving circuit includes the first output node control circuit and a second output node control circuit; a display period includes a maintenance period; the driving method includes:
in the maintenance period, stopping providing a clock signal and an input signal to the even-stage driving circuit;
in at least a part of the maintenance period, in the even-stage driving circuit, controlling, by the first output node control circuit, the first output node to be electrically connected to the second voltage end, to cause the first output circuit to control the driving signal output end to be electrically connected to the first voltage end; controlling, by the second output node control circuit, the second output node to be electrically connected to a third voltage end, to cause the second output circuit to control the driving signal output end to be electrically disconnected from the output signal end under the control of the potential of the second output node;
in the maintenance period, providing the clock signal and the input signal normally to the odd-stage driving circuit.

In a sixth aspect, the embodiments of the present disclosure provide a display device, including the above driving module.

### BRIEF DESCRIPTION OF THE DRAWINGS

FIG. 1 is a structural diagram of a driving circuit according to an embodiment of the present disclosure;

FIG. 2 is a structural diagram of a driving circuit according to at least one embodiment of the present disclosure;

FIG. 3 is a structural diagram of a driving circuit according to at least one embodiment of the present disclosure;

FIG. 4 is a structural diagram of a driving circuit according to at least one embodiment of the present disclosure;

FIG. 5 is a structural diagram of a driving circuit according to at least one embodiment of the present disclosure;

FIG. 6 is a circuit diagram of a driving circuit according to at least one embodiment of the present disclosure;

FIG. 7 is a timing diagram of at least one embodiment of the driving circuit shown in FIG. 6 in a refreshing period;

FIG. 8 is a timing diagram of at least one embodiment of the driving circuit shown in FIG. 6 in a display period;

FIG. 9 is a timing diagram of a driving circuit when stopping providing a clock signal and a first input signal in a maintenance period in the related art;

FIG. 10 is a timing diagram of at least one embodiment of the driving circuit shown in FIG. 6 in a display period;

FIG. 11 is a circuit diagram of a driving circuit according to at least one embodiment of the present disclosure;

FIG. 12 is a structural diagram of a driving circuit according to at least one embodiment of the present disclosure;

FIG. 13 is a circuit diagram of a driving circuit according to at least one embodiment of the present disclosure;

FIG. 14 is a timing diagram of at least one embodiment of the driving circuit shown in FIG. 13 in a refreshing period;

FIG. 15 is a timing diagram of at least one embodiment of the driving circuit shown in FIG. 13 in a display period;

FIG. 16 is a timing diagram of a driving circuit when stopping providing a clock signal and a second input signal in a maintenance period FB in the related art;

FIG. 17 is a timing diagram of at least one embodiment of the driving circuit shown in FIG. 13 in a display period;

FIG. 18 is a structural diagram of a driving circuit according to at least one embodiment of the present disclosure.

### DETAILED DESCRIPTION

The technical solutions in the embodiments of the present disclosure will be clearly and thoroughly described below with reference to the accompanying drawings in the embodiments of the present disclosure. Obviously, the described embodiments are only some of the embodiments of the present disclosure, not all of them. Based on the embodiments in this disclosure, all other embodiments obtained by those of ordinary skill in the art without making creative efforts fall within the scope of this disclosure.

The transistors employed in all embodiments of the present disclosure may be a thin film transistor or a field effect transistor or other devices with a same characteristics. In embodiments of the present disclosure, to distinguish between two electrodes of a transistor other than a gate electrode, one of the electrodes is referred to as a first electrode and the other is referred to as a second electrode.

In practical operation, when the transistor is the thin film transistor or the field effect transistor, the first electrode may be a drain electrode, and the second electrode may be a source electrode; or, the first electrode may be a source electrode and the second electrode may be a drain electrode.

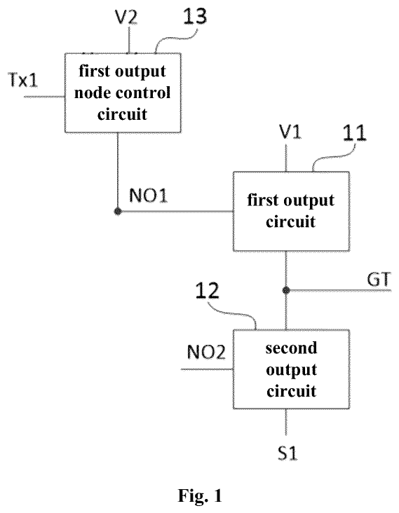

As shown in FIG. 1, the driving circuit of the embodiment of the present disclosure includes a first output circuit 11, a second output circuit 12, and a first output node control circuit 13.

A control end of the first output circuit 11 is electrically connected to a first output node NO1, and the first output circuit 11 is further electrically connected to each of a first voltage end V1 and a driving signal output end GT, and configured to control the driving signal output end GT to be electrically connected to or electrically disconnected from the first voltage end V1 under the control of a potential of the first output node NO1.

A control end of the second output circuit 12 is electrically connected to a second output node NO2, and the second output circuit is further electrically connected to each of an output signal end S1 and the driving signal output end GT, and configured to control the driving signal output end GT to be electrically connected to or electrically disconnected from the output signal end S1 under the control of a potential of the second output node NO2.

The first output node control circuit 13 is electrically connected to each of a first output control end Tx1, a second voltage end V2, and the first output node NO1, and configured to control the first output node NO1 to be electrically connected to or electrically disconnected from the second voltage end V2 under the control of a first output control signal provided by the first output control end Tx1.

In the embodiment of the present disclosure, when the driving circuit shown in FIG. 1 is in operation, and displays at a low-frequency, the display period may include a refreshing period and a maintenance period, and in the maintenance period, the clock signal end may be controlled to stop providing a corresponding clock signal; the first output node NO1 is controlled to be connected with the second voltage end V2 under the control of the first output control signal provided by the first output control end Tx1 through the first output node control circuit 13. This allows the first output circuit 11 to, under the control of the potential of the first output node NO1, control the driving signal output end GT to be electrically connected to the first voltage end V1, thereby controlling the driving signal output end GT to normally output a driving signal while reducing power consumption.

Optionally, the first voltage end V1 may be a low-voltage end, the output signal end S1 may be a second clock signal end or a high-voltage end, and the second voltage end V2 may be a high-voltage end, but the present disclosure is not limited thereto.

In a specific implementation, the second voltage end V2 may further be a first high-voltage end or a second high-voltage end, and a value of the second voltage end V2 only needs to be ensure that when the first output node NO1 is electrically connected to the second voltage end V2, the first output circuit 11 controls the driving signal output end GT to be electrically connected the first voltage end V1.

The driving circuit of at least one embodiment of the present disclosure further includes a second output node control circuit.

The second output node control circuit is electrically connected to each of a second output control end, a third voltage end, and the second output node, and configured to control the second output node to be electrically connected to or electrically disconnected from the third voltage end under the control of a second output control signal provided by the second output control end.

In a specific implementation, the driving circuit may further include a second output node control circuit, the second output node control circuit controls the second output node to be electrically connected to or electrically disconnected from the third voltage end under the control of the second output control signal.

Optionally, the third voltage end may be a low-voltage end; this is not a limitation.

In practical operation, the third voltage end can further be a first low-voltage end or a second low-voltage end, and it merely needs to ensure that when the line of the second output node control end controls the second output node to be electrically connected to the third voltage end, the second output circuit can control the driving signal output end to be electrically disconnected from the output signal end.

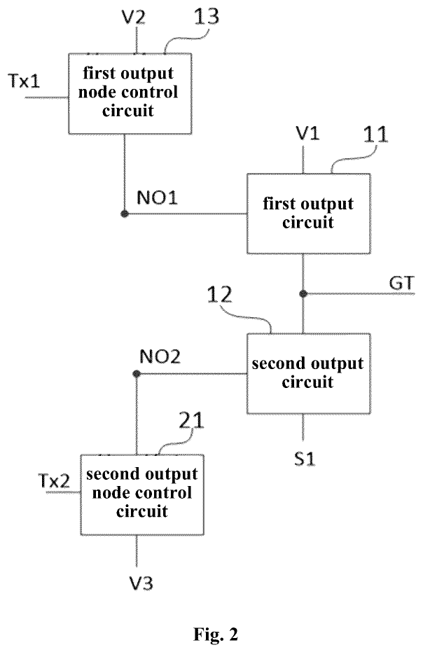

As shown in FIG. 2, based on at least one embodiment of the driving circuit shown in FIG. 1, the driving circuit according to at least one embodiment of the present disclosure further includes a second output node control circuit 21.

The second output node control circuit 21 is electrically connected to each of a second output control end Tx2, a third voltage end V3, and the second output node NO2, and configured to control the second output node NO2 to be electrically connected to or electrically disconnected from the third voltage end V3 under the control of a second output control signal provided by the second output control end Tx2.

In at least one embodiment, when the driving circuit of the present disclosure as shown in FIG. 2 is in operation, in a maintenance period included in a display period, a second output node control circuit 21 can control the second output node NO2 to be electrically connected to the third voltage end V3 under the control of a second output control signal, to cause the second output circuit 12 to control the driving signal output end GT to be electrically disconnected from the output signal end S1 under control of the potential of the second output node NO2, to control the driving signal output end GT to normally output a driving signal while reducing power consumption.

In at least one embodiment, the driving circuit of the present disclosure as shown in FIG. 2 is in operation, in a refreshing period included in a display period, each clock signal end normally provides a clock signal, a first output node control circuit 13 controls the first output node NO1 to be electrically disconnected from the second voltage end V2 under the control of a first output control signal, and the second output node control circuit 21 controls the second output node NO2 to be electrically disconnected from the third voltage end V3 under the control of a second output control signal, to cause the driving circuit to operate normally.

In at least one embodiment of the driving circuit shown in FIG. 2, the Tx1 and the Tx2 may be a same output control end, or Tx1 and Tx2 may be different output control ends.

Optionally, the first output node control circuit includes a first transistor.

A gate electrode of the first transistor is electrically connected to the first output control end, a first electrode of the first transistor is electrically connected to the second voltage end, and a second electrode of the first transistor is electrically connected to the first output node.

Optionally, the second output node control circuit includes a second transistor.

A gate electrode of the second transistor is electrically connected to the second output control end, a first electrode of the second transistor is electrically connected to the third voltage end, and a second electrode of the second transistor is electrically connected to the second output node.

In at least one embodiment of the present disclosure, the first output control end and the second output control end are a same output control end; or the first output control end and the second output control end are different output control ends.

The driving circuit of at least one embodiment of the present disclosure further includes a second node control circuit and an on-off control circuit.

The second node control circuit is electrically connected to a second node, and configured to control a potential of the second node.

The on-off control circuit is electrically connected to each of a fourth voltage end, the second node, and the second output node, and configured to control the second node to be electrically connected to or electrically disconnected from the second output node under the control of a fourth voltage signal provided by the fourth voltage end.

In a specific implementation, the driving circuit may further include a second node control circuit and an on-off control circuit; the second node control circuit controls the potential of the second node; the on-off control circuit controls the second node to be electrically connected to or electrically disconnected from the second output node under the control of a fourth voltage signal provided by the fourth voltage end.

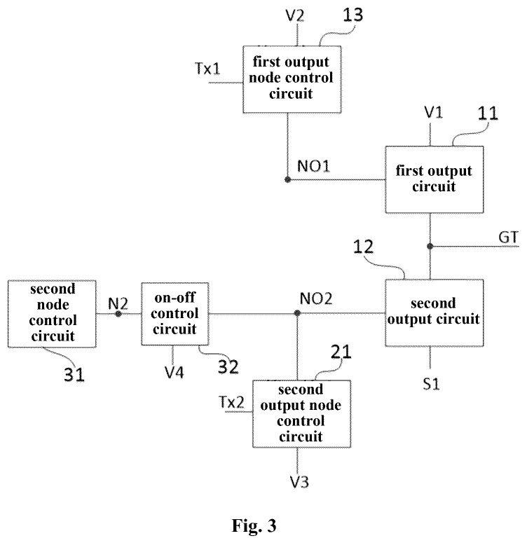

As shown in FIG. 3, based on at least one embodiment of the driving circuit shown in FIG. 2, the driving circuit further includes a second node control circuit 31 and an on-off control circuit 32.

The second node control circuit 31 is electrically connected to a second node N2, and configured to control the potential of the second node N2.

The on-off control circuit 32 is electrically connected to each of a fourth voltage end V4, the second node N2, and the second output node NO2, and configured to control the second node N2 to be electrically connected to or electrically disconnected from the second output node NO2 under the control of a fourth voltage signal provided by the fourth voltage end V4.

Optionally, when the transistor included in the on-off control circuit 32 is an n-type transistor, the fourth voltage end V4 may be a high-voltage end; or, when the transistor included in the on-off control circuit 32 is a p-type transistor, the fourth voltage end is a low-voltage end.

Optionally, the on-off control circuit includes an on-off control transistor.

A gate electrode of the on-off control transistor is electrically connected to the fourth voltage end, a first electrode of the on-off control transistor is electrically connected to the second node, and a second electrode of the on-off control transistor is electrically connected to the second output node.

The on-off control transistor is an n-type transistor, and the fourth voltage end is a high-voltage end; or, the on-off control transistor is a p-type transistor, and the fourth voltage end is a low-voltage end.

Optionally, the second node control circuit is electrically connected to each of a first clock signal end and a first input end, and configured to control the second node to be electrically connected to or electrically disconnected from the first input end under the control of a first clock signal provided by the first clock signal end.

In a specific implementation, the second node control circuit may control the second node to be electrically connected to or electrically disconnected from the first input end under the control of the first clock signal.

In at least one embodiment of the present disclosure, the second node control circuit is further electrically connected to each of a first output node, a first voltage end, and a second clock signal end, and configured to control the second node to be electrically connected to the first voltage end under the control of a potential of the first output node and a second clock signal provided by the second clock signal end.

In a specific implementation, the second node control circuit may further control the second node to be electrically connected to the first voltage end under the control of the potential of the first output node and the second clock signal.

In at least one embodiment of the present disclosure, the driving circuit of at least one embodiment of the present disclosure further includes a first output control circuit.

The first output control circuit is electrically connected to each of a first clock signal end, a fifth voltage end, the first output node, a second clock signal end, and the first voltage end, and configured to control the first output node to be electrically connected to the fifth voltage end under the control of a first clock signal provided by the first clock signal end, and control the first output node to be electrically connected to the first voltage end under the control of a second clock signal provided by the second clock signal end.

In a specific implementation, the driving circuit of at least one embodiment of the present disclosure further includes a first output control circuit.

The first output control circuit may control the first output node to be electrically connected to the fifth voltage end under the control of the first clock signal, and control the first output node to be electrically connected to the first voltage end under the control of the second clock signal.

In at least one embodiment of the present disclosure, the first output control circuit is electrically connected to each of a first clock signal end, a fifth voltage end, the first output node and the second node, and configured to control the first output node to be electrically connected to the fifth voltage end under the control of a first clock signal provided by the first clock signal end, and write the first clock signal into the first output node under the control of the potential of the second node.

In a specific implementation, the first output control circuit may control a first output node to be electrically connected to a fifth voltage end under the control of a first clock signal, and write the first clock signal into the first output node under the control of a potential of the second node.

Optionally, the fifth voltage end may be a high-voltage end, but is not limited thereto.

The driving circuit of at least one embodiment of the present disclosure further includes a first energy storage circuit and a second energy storage circuit.

The first energy storage circuit is electrically connected to each of the first output node and the first voltage end, and configured to store electric energy.

The second energy storage circuit is electrically connected to each of the second output node and the driving signal output end, and configured to store electric energy.

Optionally, the driving circuit may further include a first energy storage circuit and a second energy storage circuit, the first energy storage circuit is configured to maintain the potential of the first output node, and the second energy storage circuit may be configured to control the potential of the second output node.

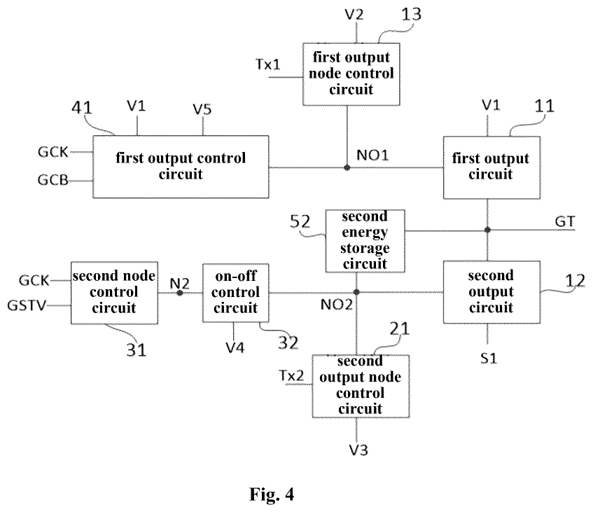

As shown in FIG. 4, based on at least one embodiment of the driving circuit shown in FIG. 3, the driving circuit according to at least one embodiment of the present disclosure further includes a second energy storage circuit 52 and a first output control circuit 41.

The second node control circuit 31 is electrically connected to each of a first clock signal end GCK and a first input end GSTV, configured to control the second node N2 to be electrically connected to or electrically disconnected from the first input end GSTV under the control of a first clock signal provided by the first clock signal end GCK.

The first output control circuit 41 is electrically connected to each of a first clock signal end GCK, a fifth voltage end V5, a first output node NO1, a second clock signal end GCB, and a first voltage end V1, configured to control the first output node NO1 to be electrically connected to the fifth voltage end V5 under the control of a first clock signal provided by the first clock signal end GCK, and control the first output node NO1 to be electrically connected to the first voltage end V1 under the control of a second clock signal provided by the second clock signal end GCB.

The second energy storage circuit 52 is electrically connected to each of the second output node NO2 and the driving signal output end GT, configured to store electric energy.

Optionally, the fifth voltage end may be a high-voltage end and the first voltage end may be a low-voltage end.

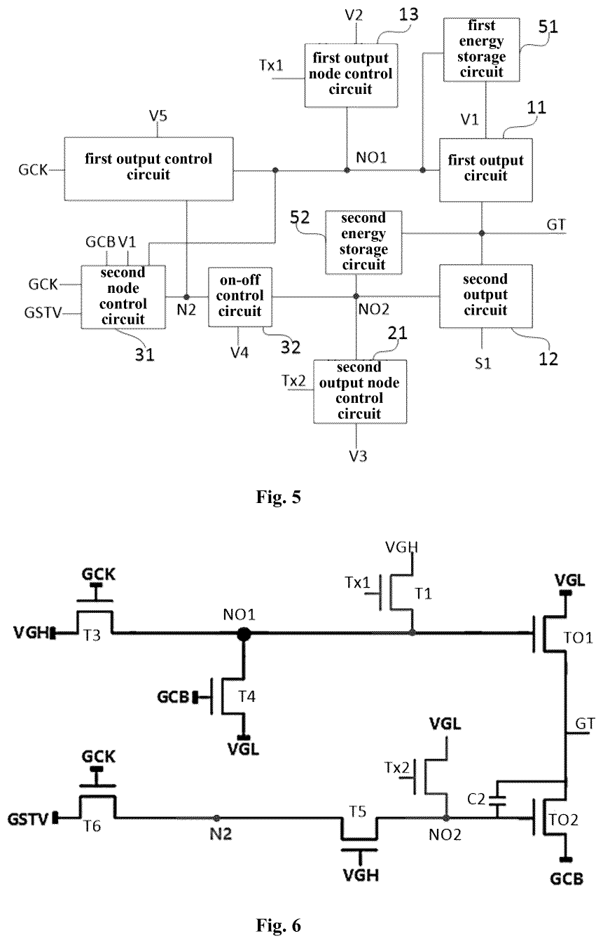

As shown in FIG. 5, based on at least one embodiment of the driving circuit shown in FIG. 3, the driving circuit according to at least one embodiment of the present disclosure further includes a first output control circuit 41.

The second node control circuit 31 is electrically connected to each of a first clock signal end GCK and a first input end GSTV, and configured to control the second node N2 to be electrically connected to or electrically disconnected from the first input end GSTV under the control of a first clock signal provided by the first clock signal end GCK.

The second node control circuit 31 is further electrically connected to each of the first output node NO1, the first voltage end V1, and the second clock signal end GCB, and configured to control the second node N2 to be electrically connected to the first voltage end V1 under the control of the potential of the first output node NO1 and the second clock signal provided by the second clock signal end GCB.

The first output control circuit 41 is electrically connected to each of a first clock signal end GCK, a fifth voltage end V5, the first output node NO1, and the second node N2, and configured to control the first output node NO1 to be electrically connected to the fifth voltage end V5 under the control of a first clock signal provided by the first clock signal end GCK, and write the first clock signal into the first output node NO1 under the control of the potential of the second node N2.

The driving circuit of at least one embodiment of the present disclosure further includes a first energy storage circuit 51 and a second energy storage circuit 52.

The first energy storage circuit 51 is electrically connected to each of the first output node NO1 and the first voltage end V1, and configured to store electric energy.

The second energy storage circuit 52 is electrically connected to each of the second output node NO2 and the driving signal output end GT, and configured to store electric energy.

As shown in FIG. 6, based on at least one embodiment of the driving circuit shown in FIG. 4, the first output node control circuit includes a first transistor T1.

A gate electrode of the first transistor T1 is electrically connected to the first output control end Tx1, a source electrode of the first transistor T1 is electrically connected to a high-voltage end VGH, and a drain electrode of the first transistor T1 is electrically connected to the first output node NO1.

The second output node control circuit includes a second transistor T2.

A gate electrode of the second transistor T2 is electrically connected to the second output control end Tx2, a source electrode of the second transistor T2 is electrically connected to a low-voltage end VGL, and a drain electrode of the second transistor T2 is electrically connected to the second output node NO2.

The first output control circuit includes a third transistor T3 and a fourth transistor T4.

The gate electrode of the third transistor T3 is electrically connected to the first clock signal end GCK, the source electrode of the third transistor T3 is electrically connected to the high-voltage end VGH, and the drain electrode of the third transistor T3 is electrically connected to the first output node NO1.

The gate electrode of the fourth transistor T4 is electrically connected to the second clock signal end GCB, the source electrode of the fourth transistor T4 is electrically connected to the low-voltage end VGL, and the drain electrode of the fourth transistor T4 is electrically connected to the first output node NO1.

The on-off control circuit includes a fifth transistor T5.

The gate electrode of the fifth transistor T5 is electrically connected to the high-voltage end VGH, the source electrode of the fifth transistor T5 is electrically connected to the second node N2, and the drain electrode of the fifth transistor T5 is electrically connected to the second output node NO.

The second node control circuit includes a sixth transistor T6.

A gate electrode of the sixth transistor T6 is electrically connected to a first clock signal end GCK, a first electrode of the sixth transistor T6 is electrically connected to a first input end GSTV, and a second electrode of the sixth transistor T6 is electrically connected to a second node N2.

The first output circuit includes a first output transistor TO1.

A gate electrode of the first output transistor TO1 is electrically connected to a first output node NO1, a source electrode of the first output transistor TO1 is electrically connected to a low-voltage end VGL, and a drain electrode of the first output transistor TO1 is electrically connected to a driving signal output end GT.

The second output circuit includes a second output transistor TO2.

A gate electrode of the second output transistor TO2 is electrically connected to a second output node NO2, a source electrode of the second output transistor TO2 is electrically connected to a second clock signal end GCB, and a drain electrode of the second output transistor TO2 is electrically connected to a driving signal output end GT.

The second energy storage circuit includes a second capacitor C2.

A first end of the second capacitor C2 is electrically connected to the second output node NO2, and a second end of the second capacitor C2 is electrically connected to the driving signal output end GT.

In at least one embodiment of the driving circuit shown in FIG. 6, all transistors are n-type transistors, but this is not a limitation.

In at least one embodiment of the driving circuit shown in FIG. 6, Tx1 and Tx2 may be a same output control end, or Tx1 and Tx2 may be different output control ends.

In at least one embodiment of the driving circuit shown in FIG. 6 of the present disclosure, the T1 controlled by the Tx1 and the T2 controlled by the Tx2 are adopted, such that when displaying at a low-frequency in the maintenance frame (i.e., maintenance period), the driving signal can be output normally even without providing a clock signal and an input signal, thereby reducing power consumption.

In at least one embodiment, when the driving circuit shown in FIG. 6 is in operation, the display period may include a refreshing period and a maintenance period when displaying at a low-frequency.

In a refreshing period, the GCK and the GCB normally output corresponding clock signals, the GSTV provides a corresponding input signal, the Tx1 and the Tx2 provide low voltage signals, the T1 and the T2 are turned off, and the driving circuit normally outputs a driving signal.

In a maintenance period, the GCK and the GCB stop providing a clock signal, the GSTV stops providing a corresponding input signal, the Tx1 and the Tx2 can both provide high voltage signals to control the T1 and the T2 to turn on, so that the TO1 is turned on, the TO2 is turned off, and the GT continues to output a low voltage signal, and thus power consumption can be reduced in the maintenance period while ensuring a stable output of the driving signal output end GT.

In at least one embodiment, when the driving circuit shown in FIG. 6 is in operation, in the maintenance period, the first output control signal provided by the Tx1 and the second output control signal provided by the Tx2 can further be square wave voltage signals, and at this time, the frequency of the first output control signal and the frequency of the second output control signal can be set to be higher than a display refreshing frequency, which is used to improve the bias leakage of the Thin Film Transistor (TFT).

At this time, when the potential of the first output control signal is a high voltage, T1 can be turned on, and when the potential of the first output control signal is a low voltage, T1 can be turned off.

When the potential of the second output control signal is a high voltage, the T2 may be turned on, and when the potential of the second output control signal is a low voltage, the T2 may be turned off.

In at least one embodiment, when the driving circuit shown in FIG. 6 is in operation, the first output control end Tx1 and the second output control end Tx2 may be different output control ends. Since leakage paths and leakage amounts of the TO1 and the TO2 are different, it causes the conduction period of the T1 to be greater than the conduction period of the T2 in the maintenance period.

In at least one embodiment, when the driving circuit shown in FIG. 6 is in operation, the frequency of the first clock signal and the frequency of the second clock signal may be equal to a frequency of a data voltage provided to a data line in the display period to reduce power consumption when displaying at a low-frequency.

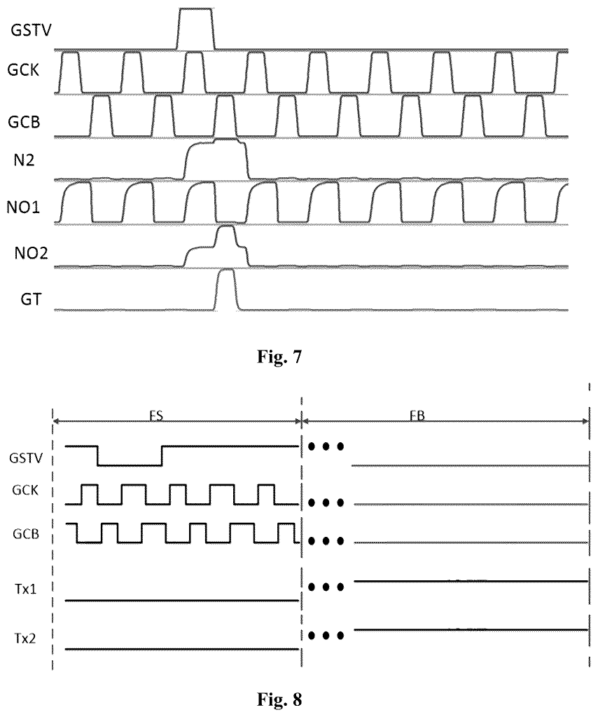

FIG. 7 is a timing diagram of at least one embodiment of the driving circuit shown in FIG. 6 in a refreshing period.

FIG. 8 is a timing diagram of at least one embodiment of the driving circuit shown in FIG. 6 in a display period.

As shown in FIG. 8, the display period includes a refreshing period FS and a maintenance period FB.

In the refreshing period FS, the GSTV normally outputs a first input signal, the GCK normally outputs a first clock signal, the GCB normally outputs a second clock signal, and the Tx outputs a low voltage signal.

In the maintenance period FB, the GSTV stops outputting the first input signal, the GCK stops outputting the clock signal, the GCB stops outputting the clock signal, and the Tx outputs the high voltage signal.

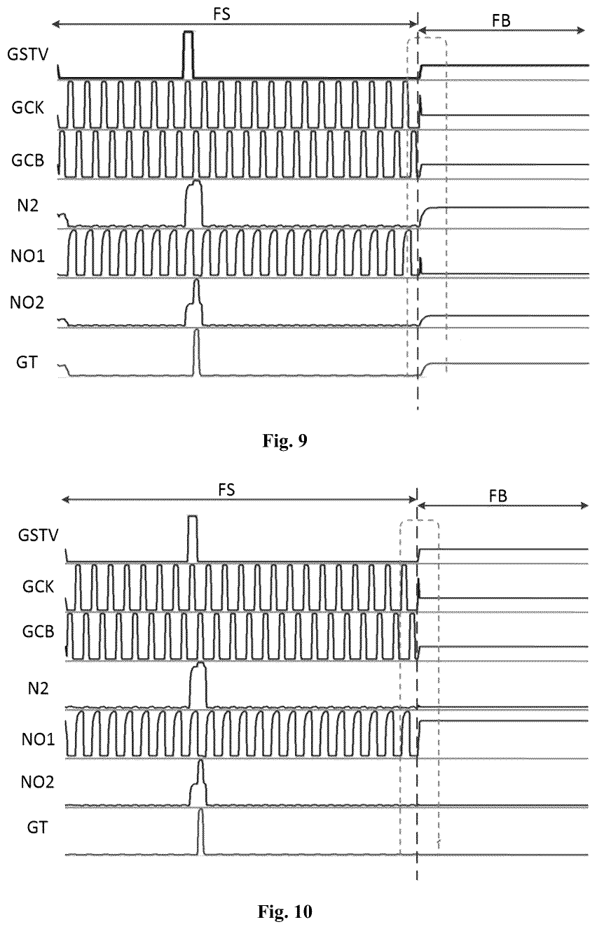

FIG. 9 is a timing diagram of a driving circuit when stopping providing a clock signal and a first input signal in a maintenance period in the related art. As shown in FIG. 9, in the maintenance period FB, there is an upward step in the potential of the driving signal provided by the GT, and the output is abnormal.

FIG. 10 is a timing diagram of at least one embodiment of the driving circuit shown in FIG. 6 in a display period.

As shown in FIG. 10, at least one embodiment of the driving circuit shown in FIG. 6 is adopted, such that the driving signal provided by the GT is normal in the maintenance period.

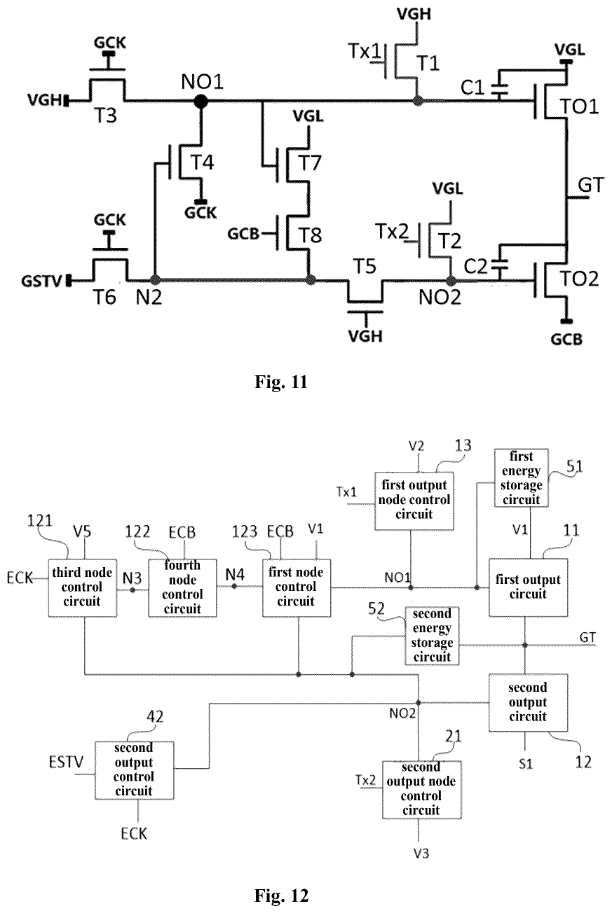

As shown in FIG. 11, based on at least one embodiment of the driving circuit shown in FIG. 5, the first output node control circuit includes a first transistor T1.

A gate electrode of the first transistor T1 is electrically connected to the first output control end Tx1, a source electrode of the first transistor T1 is electrically connected to a high-voltage end VGH, and a drain electrode of the first transistor T1 is electrically connected to the first output node NO1.

The second output node control circuit includes a second transistor T2.

A gate electrode of the second transistor T2 is electrically connected to the second output control end Tx2, a source electrode of the second transistor T2 is electrically connected to a low-voltage end VGL, and a drain electrode of the second transistor T2 is electrically connected to the second output node NO2.

The first output control circuit includes a third transistor T3 and a fourth transistor T4.

The gate electrode of the third transistor T3 is electrically connected to the first clock signal end GCK, the source electrode of the third transistor T3 is electrically connected to the high-voltage end VGH, and the drain electrode of the third transistor T3 is electrically connected to the first output node NO1.

The gate electrode of the fourth transistor T4 is electrically connected to the second node N2, the source electrode of the fourth transistor T4 is electrically connected to the first clock signal end GCK, and the drain electrode of the fourth transistor T4 is electrically connected to the first output node NO1.

The on-off control circuit includes a fifth transistor T5.

The gate electrode of the fifth transistor T5 is electrically connected to the high-voltage end VGH, the source electrode of the fifth transistor T5 is electrically connected to the second node N2, and the drain electrode of the fifth transistor T5 is electrically connected to the second output node NO2.

The second node control circuit includes a sixth transistor T6, a seventh transistor T7, and an eighth transistor T8.

A gate electrode of the sixth transistor T6 is electrically connected to a first clock signal end GCK, a first electrode of the sixth transistor T6 is electrically connected to a first input end GSTV, and a second electrode of the sixth transistor T6 is electrically connected to a second node N2.

A gate electrode of the seventh transistor T7 is electrically connected to the first output node NO1, a source electrode of the seventh transistor T7 is electrically connected to a low-voltage end VGL, and a drain electrode of the seventh transistor T7 is electrically connected to a source electrode of the eighth transistor T8.

The gate electrode of the eighth transistor T8 is electrically connected to the second clock signal end GCB, and the drain electrode of the eighth transistor T8 is electrically connected to the second node N2.

The first output circuit includes a first output transistor TO1.

A gate electrode of the first output transistor TO1 is electrically connected to a first output node NO1, a source electrode of the first output transistor TO1 is electrically connected to a low-voltage end VGL, and a drain electrode of the first output transistor TO1 is electrically connected to a driving signal output end GT.

The second output circuit includes a second output transistor TO2.

A gate electrode of the second output transistor TO2 is electrically connected to a second output node NO2, a source electrode of the second output transistor TO2 is electrically connected to a second clock signal end GCB, and a drain electrode of the second output transistor TO2 is electrically connected to a driving signal output end GT.

The first energy storage circuit includes a first capacitor C1; the second energy storage circuit includes a second capacitor C2.

A first end of the C1 is electrically connected to a first output node NO1, and a second end of the C1 is electrically connected to a low-voltage end VGL.

A first end of the C2 is electrically connected to the second output node NO2, and a second end of the C2 is electrically connected to the driving signal output end GT.

In at least one embodiment of the driving circuit shown in FIG. 11, all transistors may be n-type transistors, but this is not a limitation.

In at least one embodiment of the driving circuit shown in FIG. 11, the Tx1 and the Tx2 may be a same output control end, or the Tx1 and the Tx2 may be different output control ends.

At least one embodiment of the driving circuit shown in FIG. 11 of the present disclosure, the T1 controlled by the Tx1 and the T2 controlled by the Tx2 are adopted, such that when displaying at a low-frequency in the maintenance frame (i.e., maintenance period), the driving signal can be output normally even without providing a clock signal and an input signal, thereby saving power consumption.

In at least one embodiment, when the driving circuit shown in FIG. 11 of the present disclosure is in operation, the display period may include a refreshing period and a maintenance period when displaying at a low-frequency.

In the refreshing period, the GCK and the GCB normally output corresponding clock signals, the GSTV provides a corresponding input signal, the Tx1 and the Tx2 provide low voltage signals, the T1 and the T2 are turned off, and the driving circuit normally outputs a driving signal.

In the maintenance period, the GCK and the GCB stop providing clock signals, the GSTV stops providing a corresponding input signal, the Tx1 and the Tx2 can both provide high voltage signals to control the T1 and the T2 to turn on, so that the TO1 is turned on, the TO2 is turned off, and the GT continues to output a low voltage signal, and thus power consumption can be reduced in the maintenance period while ensuring a stable output of the driving signal output end GT.

In at least one embodiment, when the driving circuit shown in FIG. 11 is in operation, in a maintenance period, the first output control signal provided by the Tx1 and the second output control signal provided by the Tx2 can further be square wave voltage signals, and at this time, the frequency of the first output control signal and the frequency of the second output control signal can be set to be higher than a display refreshing frequency, which is used to improve the bias leakage of the TFT.

At this time, when the potential of the first output control signal is a high voltage, the T1 can be turned on, and when the potential of the first output control signal is a low voltage, the T1 can be turned off.

When the potential of the second output control signal is a high voltage, the T2 may be turned on, and when the potential of the second output control signal is a low voltage, the T2 may be turned off.

In at least one embodiment, when the driving circuit shown in FIG. 11 is in operation, the first output control end Tx1 and the second output control end Tx2 may be different output control ends. Since leakage paths and leakage amounts for the TO1 and the TO2 are different, it enables the conduction period of the T1 to be greater than the conduction period of the T2 in the maintenance period In at least one embodiment, when the driving circuit shown in FIG. 11 is in operation, the frequency of the first clock signal and the frequency of the second clock signal may be equal to a frequency of a data voltage provided to a data line in the display period to reduce power consumption when displaying at a low-frequency.

In at least one embodiment of the present disclosure, the driving circuit may further include a first control circuit.

The first control circuit includes a third node control circuit, a fourth node control circuit, and a first node control circuit.

The third node control circuit is electrically connected to each of a third node, a third clock signal end, a fifth voltage end, and the second output node, and configured to control the third node to be electrically connected to the fifth voltage end under the control of a third clock signal provided by the third clock signal end, and writes the third clock signal into the third node under the control of the potential of the second output node, and configured to maintain a potential of the third node.

The fourth node control circuit is electrically connected to each of the third node, a fourth clock signal end, and a fourth node, and configured to write a fourth clock signal provided by the fourth clock signal end into the fourth node under the control of the potential of the third node.

The first node control circuit is electrically connected to each of the fourth clock signal end, the fourth node, the first output node, the second output node, and the first voltage end, and configured to control the fourth node to be electrically connected to the first output node under the control of the fourth clock signal, and control the first output node to be electrically connected to the first voltage end under the control of the potential of the second output node.

In a specific implementation, the first control circuit may include a third node control circuit, a fourth node control circuit and a first node control circuit; the third node control circuit is configured to control the second output node to be electrically connected to the fifth voltage end under the control of a third clock signal, and write the third clock signal into the third node under the control of the potential of the second output node, and configured to maintain the potential of the third node; the fourth node control circuit is configured to write a fourth clock signal into the fourth node under the control of the potential of the third node; the first node control circuit is configured to control the fourth node to be electrically connected to the first output node under the control of the fourth clock signal, and control the first output node to be electrically connected to the first voltage end under the control of the potential of the second output node.

Optionally, the fifth voltage end may be a high-voltage end, but is not limited thereto.

Optionally, the driving circuit of at least one embodiment of the present disclosure further includes a second output control circuit.

The second output control circuit is electrically connected to each of the second output node, a third clock signal end, and a second input end, and configured to control the second output node to be electrically connected to the second input end under the control of a third clock signal provided by the third clock signal end.

In a specific implementation, the second output control circuit may further control the second output node to be electrically connected to the second input end under the control of a third clock signal.

As shown in FIG. 12, based on at least one embodiment of the driving circuit shown in FIG. 2, the driving circuit according to at least one embodiment of the present disclosure further includes a first control circuit and a second output control circuit 42.

The first control circuit includes a third node control circuit 121, a fourth node control circuit 122, and a first node control circuit 123.

The third node control circuit 121 is electrically connected to each of a third node N3, a third clock signal end ECK, a fifth voltage end V5, and a second output node NO2, and configured to control the third node N3 to be electrically connected to the fifth voltage end V5 under the control of a third clock signal provided by the third clock signal end ECK, and write the third clock signal into the third node N3 under the control of the potential of the second output node NO2, and configured to maintain the potential of the third node N3.

The fourth node control circuit 122 is electrically connected to each of the third node N3, a fourth clock signal end ECB, and a fourth node N4, and configured to write a fourth clock signal provided by the fourth clock signal end ECB into the fourth node N4 under the control of the potential of the third node N3.

The first node control circuit 123 is electrically connected to each of the fourth clock signal end ECB, the fourth node N4, a first output node NO1, a second output node NO2, and a first voltage end V1, and configured to control the fourth node N4 to be electrically connected to the first output node NO1 under the control of the fourth clock signal, and control the first output node NO1 to be electrically connected to the first voltage end V1 under the control of the potential of the second output node NO2.

The second output control circuit 42 is electrically connected to each of a second output node NO2, a third clock signal end ECK, and a second input end ESTV, and configured to control the second output node NO2 to be electrically connected to the second input end ESTV under the control of a third clock signal provided by the third clock signal end ECK.

The driving circuit further includes a first energy storage circuit 51 and a second energy storage circuit 52.

The first energy storage circuit 51 is electrically connected to each of the first output node NO1 and the first voltage end V1, and configured to store electric energy.

The second energy storage circuit 52 is electrically connected to each of the second output node NO2 and the driving signal output end GT, and configured to store electric energy.

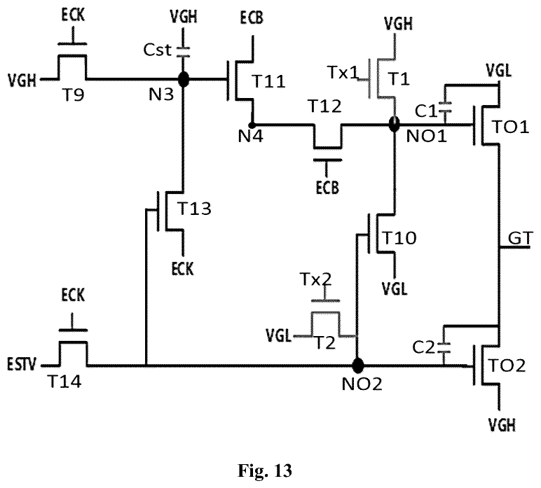

As shown in FIG. 13, based on at least one embodiment of the driving circuit shown in FIG. 12, the first output node control circuit includes a first transistor T1.

A gate electrode of the first transistor T1 is electrically connected to the first output control end Tx1, a source electrode of the first transistor T1 is electrically connected to a high-voltage end VGH, and a drain electrode of the first transistor T1 is electrically connected to the first output node NO1.

The second output node control circuit includes a second transistor T2.

A gate electrode of the second transistor T2 is electrically connected to the second output control end Tx2, a source electrode of the second transistor T2 is electrically connected to a low-voltage end VGL, and a drain electrode of the second transistor T2 is electrically connected to the second output node NO2.

The third node control circuit includes a ninth transistor T9, a tenth transistor T10, and a storage capacitor Cst.

The gate electrode of the ninth transistor T9 is electrically connected to the third clock signal end ECK, the source electrode of the ninth transistor T9 is electrically connected to the high-voltage end VGH, and the drain electrode of the ninth transistor T9 is electrically connected to the third node N3.

The gate electrode of the tenth transistor T10 is electrically connected to the second output node NO2, the source electrode of the tenth transistor T10 is electrically connected to the third clock signal end, and the drain electrode of the tenth transistor T10 is electrically connected to the third node N3.

A first end of the Cst is electrically connected to the third node N3, and a second end of the Cst is electrically connected to the high-voltage end VGH.

The fourth node control circuit includes an eleventh transistor T11.

The gate electrode of the eleventh transistor T11 is electrically connected to the third node N3, the source electrode of the eleventh transistor T11 is electrically connected to the fourth clock signal end ECB, and the drain electrode of the eleventh transistor T11 is electrically connected to the fourth node N4.

The first node control circuit includes a twelfth transistor T12 and a thirteenth transistor T13.

The gate electrode of the T12 is electrically connected to the fourth clock signal end ECB, the source electrode of the T12 is electrically connected to the fourth node N4, and the drain electrode of the T12 is electrically connected to the first output node NO1.

The gate electrode of the T13 is electrically connected to the second output node NO2, the source electrode of the T13 is electrically connected to the low-voltage end VGL, and the drain electrode of the T13 is electrically connected to the first output node NO1.

The second output control circuit includes a fourteenth transistor T14.

A gate electrode of the fourteenth transistor T14 is electrically connected to a third clock signal end ECK, a source electrode of the T14 is electrically connected to a second input end ESTV, and a drain electrode of the T14 is electrically connected to a second output node NO2.

The first output circuit includes a first output transistor TO1.

A gate electrode of the first output transistor TO1 is electrically connected to a first output node NO1, a source electrode of the first output transistor TO1 is electrically connected to a low-voltage end VGL, and a drain electrode of the first output transistor TO1 is electrically connected to a driving signal output end GT.

The second output circuit includes a second output transistor TO2.

A gate electrode of the second output transistor TO2 is electrically connected to a second output node NO2, a source electrode of the second output transistor TO2 is electrically connected to a second clock signal end GCB, and a drain electrode of the second output transistor TO2 is electrically connected to a driving signal output end GT.

The first energy storage circuit includes a first capacitor C1; the second energy storage circuit includes a second capacitor C2.

A first end of the C1 is electrically connected to a first output node NO1, and a second end of the C1 is electrically connected to a low-voltage end VGL.

A first end of the C2 is electrically connected to the second output node NO2, and a second end of the C2 is electrically connected to the driving signal output end GT.

At least one embodiment of the driving circuit shown in FIG. 13 may be configured to provide a light-emitting control signal, i.e. the driving signal output end GT may be configured to output a light-emitting control signal.

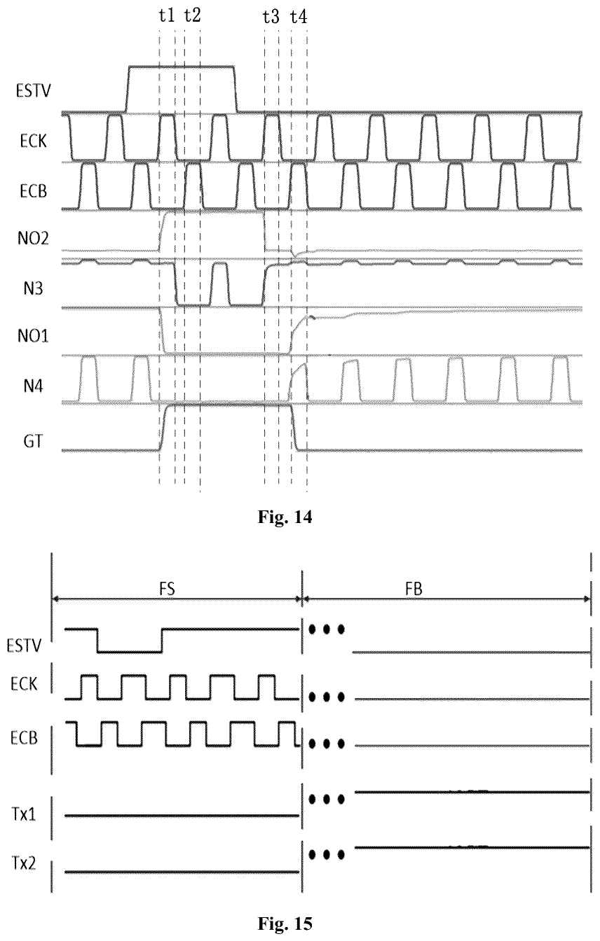

FIG. 14 is a timing diagram of at least one embodiment of the driving circuit shown in FIG. 13 in a refreshing period. In the refreshing period, the Tx1 and the Tx2 provide low voltage signals, and both T1 and T2 are turned off.

In FIG. 14, a phase labeled t1 is a first phase included in the refreshing period, a phase labeled t2 is a second phase included in the refreshing period, a phase labeled t3 is a third phase included in the refreshing period, and a phase labeled t4 is a fourth phase included in the refreshing period.

In the first phase t1, the T14 is turned on, and the potential of the NO2 is a high voltage, the T13 is turned on, and the potential of the NO1 is a low voltage.

In the second phase t2, the T10 is turned on, the potential of the N3 is a low voltage, and the potential of the NO1 and the potential of the NO2 are maintained at an original potential through a capacitor.

In the third phase t3, the T14 is turned on, the potential of the NO2 is a low voltage, the potential of the N3 is a high voltage, and the potential of the NO1 is maintained at a low voltage.

In the fourth phase t4, the T11 and the T12 are turned on, the potential of the NO1 is a high voltage and the potential of the NO2 is maintained at a low voltage.

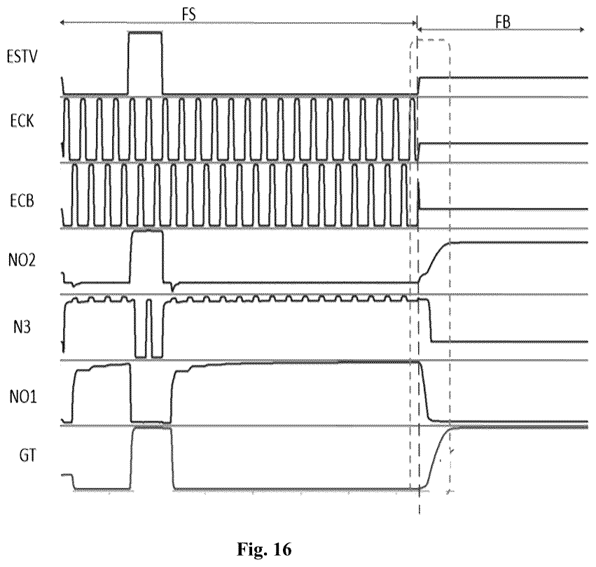

FIG. 15 is a timing diagram of at least one embodiment of the driving circuit shown in FIG. 13 in a display period.

As shown in FIG. 15, in at least one embodiment, when the driving circuit shown in FIG. 13 is in operation, the display period includes a refreshing period FS and a maintenance period FB.

In the refreshing period FS, the ESTV normally provides a second input signal, the ECK normally provides a third clock signal, the ECB normally provides a fourth clock signal, the Tx1 and the Tx2 both provide a low voltage signal, and the T1 and the T2 are turned off.

In the maintenance period FB, the ESTV stops providing the second input signal, the ECK stops providing the third clock signal, the ECB stops providing the fourth clock signal, the Tx1 and the Tx2 are both providing the high voltage signal, the T1 and the T2 are turned on, the TO1 is turned on, the TO2 is turned off.

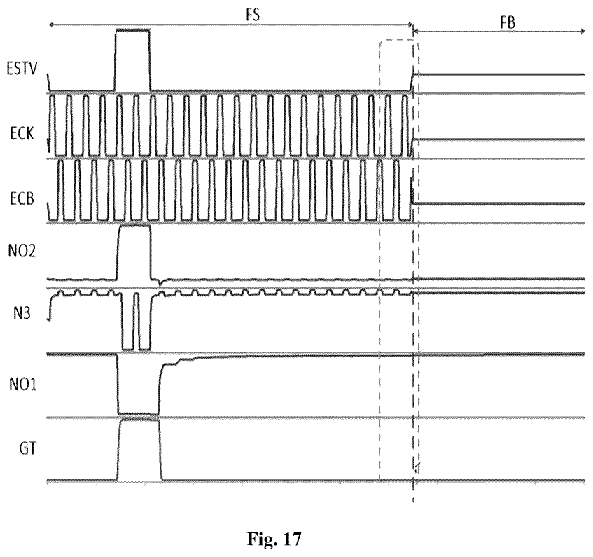

FIG. 16 is a timing diagram of the driving circuit when stopping providing a clock signal and a second input signal in a maintenance period FB in the related art. As shown in FIG. 16, in the maintenance period, there is an upward step in the potential of the driving signal provided by the GT, and the output is abnormal.

FIG. 17 is a timing diagram of at least one embodiment of the driving circuit shown in FIG. 13 in a display period.

As shown in FIG. 17, by adopting at least one embodiment of the driving circuit shown in FIG. 13, in the maintenance period FB, the driving signal provided by the GT is normal.

In at least one embodiment of the present disclosure, the driving circuit may further include a first on-off control circuit.

The first output node is electrically connected to the control end of the first output circuit through the first on-off control circuit.

The first on-off control circuit is configured to control the first output node to be electrically connected to the control end of the first output circuit in at least a part of a maintenance period included in a display period.

In a specific implementation, the driving circuit of at least one embodiment of the present disclosure may further include a first on-off control circuit, the first on-off control circuit controls the first output node to be electrically connected to a control end of the first output circuit in at least a part of the maintenance period.

In at least one embodiment of the present disclosure, the driving circuit may further include a second on-off control circuit; the second output node is electrically connected to a control end of the second output circuit through the second on-off control circuit.

The second on-off control circuit is configured to control the second output node to be electrically connected to the control end of the second output circuit in at least a part of a maintenance period included in a display period.

In a specific implementation, the driving circuit of at least one embodiment of the present disclosure may further include a second on-off control circuit, the second on-off control circuit controls the second output node to be electrically connected to a control end of the second output circuit in at least a part of the maintenance period.

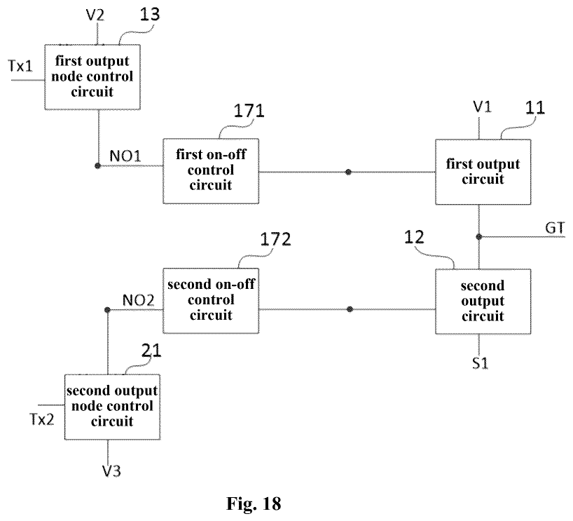

As shown in FIG. 18, based on at least one embodiment of the driving circuit shown in FIG. 2, the driving circuit may further include a first on-off control circuit 171 and a second on-off control circuit 172.

The first output node NO1 is electrically connected to a control end of the first output circuit 11 through the first on-off control circuit 171.

The first on-off control circuit 171 is configured to control the first output node NO1 to be electrically connected to a control end of the first output circuit 11 in least part of the maintenance period included in the display period.

The second output node NO2 is electrically connected to a control end of the second output circuit 12 through the second on-off control circuit 172.

The second on-off control circuit 172 is configured to control the second output node NO2 to be electrically connected to the control end of the second output circuit 12 in at least part of the maintenance period included by the display period.

A driving method according to the embodiments of the present disclosure is applied to the above driving circuit; a display period includes a refreshing period and a maintenance period; the driving method includes:
in the refreshing period, controlling, by a first output node control circuit, a first output node to be electrically disconnected from a second voltage end under the control of a first output control signal provided by a first output control end;
in at least a part of the maintenance period, controlling, by the first output node control circuit, the first output node to be electrically connected to the second voltage end under the control of the first output control signal provided by the first output control end, to cause a first output circuit to control a driving signal output end to be electrically connected to a first voltage end under the control of a potential of the first output node.

In at least one embodiment of the present disclosure, the driving circuit further includes a second output node control circuit; the driving method includes:
in the refreshing period, controlling, by the second output node control circuit, a second output node to be electrically disconnected from a third voltage end under the control of a second output control signal provided by a second output control end;
in at least a part of the maintenance period, controlling, by the second output node control circuit, the second output node to be electrically connected to the third voltage end under the control of the second output control signal provided by the second output control end, to cause a second output circuit to control the driving signal output end to be electrically disconnected from an output signal end under the control of a potential of the second output node.

In at least one embodiment of the present disclosure, the driving circuit further includes a first output control circuit; the first output control circuit is electrically connected to a first clock signal end; the driving circuit further includes a second node control circuit and an on-off control circuit; the second node control circuit is electrically connected to the first clock signal end, and an output signal end is a second clock signal end.

A frequency of a first clock signal provided by the first clock signal end and a frequency of a second clock signal provided by the second clock signal end are equal to a frequency of a data voltage provided to a data line in the display period, to reduce power consumption.

Optionally, the first output control end and the second output control end are different output ends.

In the maintenance period, a first period is a period where the first output node is controlled by the first output node control circuit to be electrically connected to the second voltage end; a second period is a period where the second output node is controlled by the second output node control circuit to be electrically connected to the third voltage end; the first period is greater than the second period.

Optionally, the first output control signal is a square wave signal, and the second output control signal is a square wave signal.

A frequency of the first output control signal is greater than a display refreshing frequency, and a frequency of the second output control signal is greater than the display refreshing frequency, which is used to improve the bias leakage of the TFT.

In at least one embodiment of the present disclosure, in the refreshing period, the first output control signal is a first control voltage signal and the second output control signal is a second control voltage signal.

In the maintenance period, the first output control signal is a third control voltage signal, and the second output control signal is a fourth control voltage signal.

The first control voltage signal is different from the third control voltage signal, and the second control voltage signal is different from the fourth control voltage signal.

Optionally, the first control voltage signal, the second control voltage signal, the third control voltage signal, and the fourth control voltage signal are direct current voltage signals.

For example, the first control voltage signal and the third control voltage signal may be low voltage signals, and the second control voltage signal and the fourth control voltage signal may be high voltage signals, but this is not a limitation.

Optionally, the first control voltage signal is a direct current voltage signal, and the second control voltage signal is a square wave voltage signal.

The third control voltage signal is a direct current voltage signal, and the fourth control voltage signal is a square wave voltage signal.

For example, the first control voltage signal and the third control voltage signal may be low voltage signals, and the second control voltage signal and the fourth control voltage signal may be square wave voltage signals, but this is not a limitation.

The driving method of at least one embodiment of the present disclosure further includes:
in the maintenance period, stopping providing clock signals to each of the clock signal ends, and stopping providing input signals to each of the input ends, to reduce power consumption.

A driving module according to an embodiment of the present disclosure includes multiple stages of the driving circuit.

A driving method according to the embodiments of the present disclosure is applied to the above driving module; the driving module includes an odd-stage driving circuit and an even-stage driving circuit; the driving circuit includes a first output node control circuit and a second output node control circuit; a display period includes a maintenance period; the driving method includes:
in the maintenance period, stopping providing a clock signal and an input signal to the odd-stage driving circuit;
in at least a part of the maintenance period, in the odd-stage driving circuit, controlling, by the first output node control circuit, a first output node to be electrically connected to a second voltage end, to cause a first output circuit to control a driving signal output end to be electrically connected to a first voltage end; controlling, by the second output node control circuit, a second output node to be electrically connected to a third voltage end, to cause a second output circuit to control the driving signal output end to be electrically disconnected from an output signal end under the control of a potential of the second output node;
in the maintenance period, providing the clock signal and the input signal normally to the even-stage driving circuit.

In a specific implementation, the output control signal may be provided for the odd-stage driving circuit and the even-stage driving circuit respectively. In the maintenance period, the clock signal and the input signal to the odd-stage driving circuit may be stopped, while the clock signal and the input signal to the even-stage driving circuit may be normally provided.

A driving method according to the embodiments of the present disclosure is applied to the above driving module; the driving module includes an odd-stage driving circuit and an even-stage driving circuit; the driving circuit includes a first output node control circuit and a second output node control circuit; a display period includes a maintenance period; the driving method includes:
in the maintenance period, stopping providing a clock signal and an input signal to the even-stage driving circuit;
in at least a part of the maintenance period, in the even-stage driving circuit, controlling, by the first output node control circuit, a first output node to be electrically connected to a second voltage end, to cause a first output circuit to control a driving signal output end to be electrically connected to a first voltage end; controlling, by the second output node control circuit, a second output node to be electrically connected to a third voltage end, to cause a second output circuit to control the driving signal output end to be electrically disconnected from an output signal end under the control of a potential of the second output node;
in the maintenance period, providing the clock signal and the input signal normally to the odd-stage driving circuit.

In a specific implementation, the output control signal may be provided for the odd-stage driving circuit and the even-stage driving circuit respectively, in the maintenance period, the clock signal and the input signal to the even-stage driving circuit may be stopped, while the clock signal and the input signal to the odd-stage driving circuit may be normally provided.

A display device according to an embodiment of the present disclosure includes the above driving module.

The above describes the preferred embodiments of the present disclosure. It should be noted that, for a person of ordinary skill in the art, various modifications and enhancements can be made without departing from the principles described herein, and these modifications and enhancements should also be considered to be within the protection scope of the present disclosure.

1. A driving circuit, comprising a first output circuit, a second output circuit, and a first output node control circuit, wherein
a control end of the first output circuit is electrically connected to a first output node, and the first output circuit is further electrically connected to each of a first voltage end and a driving signal output end, and configured to control the driving signal output end to be electrically connected to or electrically disconnected from the first voltage end under the control of a potential of the first output node;
a control end of the second output circuit is electrically connected to a second output node, and the second output circuit is further electrically connected to each of an output signal end and the driving signal output end, and configured to control the driving signal output end to be electrically connected to or electrically disconnected from the output signal end under the control of a potential of the second output node;
the first output node control circuit is electrically connected to each of a first output control end, a second voltage end, and the first output node, and configured to control the first output node to be electrically connected to or electrically disconnected from the second voltage end under the control of a first output control signal provided by the first output control end.

2. The driving circuit according to claim 1, further comprising a second output node control circuit, wherein
the second output node control circuit is electrically connected to each of a second output control end, a third voltage end, and the second output node, and configured to control the second output node to be electrically connected to or electrically disconnected from the third voltage end under the control of a second output control signal provided by the second output control end.

3. The driving circuit according to claim 1, wherein the first output node control circuit comprises a first transistor;
a gate electrode of the first transistor is electrically connected to the first output control end, a first electrode of the first transistor is electrically connected to the second voltage end, and a second electrode of the first transistor is electrically connected to the first output node.

4. The driving circuit according to claim 2, wherein the second output node control circuit comprises a second transistor;
a gate electrode of the second transistor is electrically connected to the second output control end, a first electrode of the second transistor is electrically connected to the third voltage end, and a second electrode of the second transistor is electrically connected to the second output node;
or,
wherein the first output control end and the second output control end are a same output control end; or,
the first output control end and the second output control end are different output control ends.

5. (canceled)

6. The driving circuit according to claim 2, further comprising a second node control circuit and an on-off control circuit, wherein
the second node control circuit is electrically connected to a second node, and configured to control a potential of the second node;
the on-off control circuit is electrically connected to each of a fourth voltage end, the second node, and the second output node, and configured to control the second node to be electrically connected to or electrically disconnected from the second output node under the control of a fourth voltage signal provided by the fourth voltage end.

7. The driving circuit according to claim 6, wherein the on-off control circuit comprises an on-off control transistor;
a gate electrode of the on-off control transistor is electrically connected to the fourth voltage end, a first electrode of the on-off control transistor is electrically connected to the second node, and a second electrode of the on-off control transistor is electrically connected to the second output node;
the on-off control transistor is an n-type transistor, and the fourth voltage end is a high-voltage end; or, the on-off control transistor is a p-type transistor, and the fourth voltage end is a low-voltage end.

8. The driving circuit according to claim 1, wherein the driving circuit further comprises a first on-off control circuit;
the first output node is electrically connected to the control end of the first output circuit through the first on-off control circuit;
the first on-off control circuit is configured to control the first output node to be electrically connected to the control end of the first output circuit in at least a part of a maintenance period comprised in a display period;
or,
wherein the driving circuit further comprises a first output control circuit, wherein
the first output control circuit is electrically connected to each of a first clock signal end, a fifth voltage end, the first output node, a second clock signal end, and the first voltage end, and configured to control the first output node to be electrically connected to the fifth voltage end under the control of a first clock signal provided by the first clock signal end, and control the first output node to be electrically connected to the first voltage end under the control of a second clock signal provided by the second clock signal end.

9. The driving circuit according to claim 2, further comprising a second on-off control circuit; wherein
the second output node is electrically connected to the control end of the second output circuit through the second on-off control circuit;
the second on-off control circuit is configured to control the second output node to be electrically connected to the control end of the second output circuit in at least a part of a maintenance period comprised in a display period;
or,
wherein the driving circuit further comprises a second output control circuit, wherein
the second output control circuit is electrically connected to each of the second output node, a third clock signal end, and a second input end, and configured to control the second output node to be electrically connected to the second input end under the control of a third clock signal provided by the third clock signal end.

10. The driving circuit according to claim 6, wherein the second node control circuit is electrically connected to each of a first clock signal end and a first input end, and configured to control the second node to be electrically connected to or electrically disconnected from the first input end under the control of a first clock signal provided by the first clock signal end;
wherein the second node control circuit is further electrically connected to each of the first output node, the first voltage end, and a second clock signal end, and configured to control the second node to be electrically connected to the first voltage end under the control of the potential of the first output node and a second clock signal provided by the second clock signal end.

11. (canceled)

12. (canceled)

13. The driving circuit according to claim 6, further comprising a first output control circuit, wherein
the first output control circuit is electrically connected to each of a first clock signal end, a fifth voltage end, the first output node, and the second node, and configured to control the first output node to be electrically connected to the fifth voltage end under the control of a first clock signal provided by the first clock signal end, and write the first clock signal into the first output node under the control of the potential of the second node;
wherein the driving circuit further comprises a first energy storage circuit and a second energy storage circuit, wherein
the first energy storage circuit is electrically connected to each of the first output node and the first voltage end, and configured to store electric energy;
the second energy storage circuit is electrically connected to each of the second output node and the driving signal output end, and configured to store electric energy.

14. (canceled)

15. The driving circuit according to claim 1, further comprising a first control circuit, wherein
the first control circuit comprises a third node control circuit, a fourth node control circuit, and a first node control circuit;
the third node control circuit is electrically connected to each of a third node, a third clock signal end, a fifth voltage end, and the second output node, and configured to control the third node to be electrically connected to the fifth voltage end under the control of a third clock signal provided by the third clock signal end, and write the third clock signal into the third node under the control of the potential of the second output node, and maintain a potential of the third node;
the fourth node control circuit is electrically connected to each of the third node, a fourth clock signal end, and a fourth node, and configured to write a fourth clock signal provided by the fourth clock signal end into the fourth node under the control of the potential of the third node;
the first node control circuit is electrically connected to each of the fourth clock signal end, the fourth node, the first output node, the second output node, and the first voltage end, and configured to control the fourth node to be electrically connected to the first output node under the control of the fourth clock signal, and control the first output node to be electrically connected to the first voltage end under the control of the potential of the second output node.

16. (canceled)

17. A driving method applied to the driving circuit according to claim 1, wherein a display period comprises a refreshing period and a maintenance period; the driving method comprises:
in the refreshing period, controlling, by the first output node control circuit, the first output node to be electrically disconnected from the second voltage end under the control of the first output control signal provided by the first output control end;
in at least a part of the maintenance period, controlling, by the first output node control circuit, the first output node to be electrically connected to the second voltage end under the control of the first output control signal provided by the first output control end, to cause the first output circuit to control the driving signal output end to be electrically connected to the first voltage end under the control of the potential of the first output node.

18. The driving method according to claim 17, wherein the driving circuit further comprises a second output node control circuit; the driving method comprises:
in the refreshing period, controlling, by the second output node control circuit, the second output node to be electrically disconnected from a third voltage end under the control of a second output control signal provided by a second output control end;
in at least a part of the maintenance period, controlling, by the second output node control circuit, the second output node to be electrically connected to the third voltage end under the control of the second output control signal provided by the second output control end, to cause the second output circuit to control the driving signal output end to be electrically disconnected from the output signal end under the control of the potential of the second output node.

19. The driving method according to claim 18, wherein the driving circuit further comprises a first output control circuit; the first output control circuit is electrically connected to a first clock signal end; the driving circuit further comprises a second node control circuit and an on-off control circuit; the second node control circuit is electrically connected to the first clock signal end, and the output signal end is a second clock signal end;
a frequency of a first clock signal provided by the first clock signal end and a frequency of a second clock signal provided by the second clock signal end are equal to a frequency of a data voltage provided to a data line in the display period;
or,
wherein the first output control end and the second output control end are different output ends;
in the maintenance period, a first period is a period where the first output node is controlled by the first output node control circuit to be electrically connected to the second voltage end; a second period is a period where the second output node is controlled by the second output node control circuit to be electrically connected to the third voltage end; the first period is greater than the second period;
or,
wherein the first output control signal is a square wave signal, and the second output control signal is a square wave signal;
a frequency of the first output control signal is greater than a display refreshing frequency, and a frequency of the second output control signal is greater than the display refreshing frequency.

20. (canceled)

21. (canceled)

22. The driving method according to claim 18, wherein in the refreshing period, the first output control signal is a first control voltage signal, and the second output control signal is a second control voltage signal;
in the maintenance period, the first output control signal is a third control voltage signal, and the second output control signal is a fourth control voltage signal;
the first control voltage signal is different from the third control voltage signal, and the second control voltage signal is different from the fourth control voltage signal;
wherein the first control voltage signal, the second control voltage signal, the third control voltage signal, and the fourth control voltage signal are direct current voltage signals;
or,
wherein the first control voltage signal is a direct current voltage signal, and the second control voltage signal is a square wave voltage signal;
the third control voltage signal is a direct current voltage signal, and the fourth control voltage signal is a square wave voltage signal.

23. (canceled)

24. (canceled)

25. The driving method according to claim 17, further comprising:
in the maintenance period, stopping providing a clock signal to each of clock signal ends, and stopping providing an input signal to each of input ends.

26. A driving module, comprising multiple stages of the driving circuits each according to claim 1.

27. A driving method applied to the driving module according to claim 26, wherein the driving module comprises an odd-stage driving circuit and an even-stage driving circuit; the driving circuit comprises the first output node control circuit and a second output node control circuit; a display period comprises a maintenance period; the driving method comprises:
in the maintenance period, stopping providing a clock signal and an input signal to the odd-stage driving circuit;
in at least a part of the maintenance period, in the odd-stage driving circuit, controlling, by the first output node control circuit, the first output node to be electrically connected to the second voltage end, to cause the first output circuit to control the driving signal output end to be electrically connected to the first voltage end; controlling, by the second output node control circuit, the second output node to be electrically connected to a third voltage end, to cause the second output circuit to control the driving signal output end to be electrically disconnected from the output signal end under the control of the potential of the second output node;
in the maintenance period, providing the clock signal and the input signal normally to the even-stage driving circuit.

28. A driving method applied to the driving module according to claim 26, wherein the driving module comprises an odd-stage driving circuit and an even-stage driving circuit; the driving circuit comprises the first output node control circuit and a second output node control circuit; a display period comprises a maintenance period; the driving method comprises:
in the maintenance period, stopping providing a clock signal and an input signal to the even-stage driving circuit;
in at least a part of the maintenance period, in the even-stage driving circuit, controlling, by the first output node control circuit, the first output node to be electrically connected to the second voltage end, to cause the first output circuit to control the driving signal output end to be electrically connected to the first voltage end; controlling, by the second output node control circuit, the second output node to be electrically connected to a third voltage end, to cause the second output circuit to control the driving signal output end to be electrically disconnected from the output signal end under the control of the potential of the second output node;
in the maintenance period, providing the clock signal and the input signal normally to the odd-stage driving circuit.

29. A display device comprising the driving module according to claim 26.
